(19) United States
(12) Patent Application Publication
(10) Pub. No.: US 2005/0165651 A1
(43) Pub. Date: Jul. 28, 2005

(54) Point of sale business transaction data gathering using portable memory device

(76) Inventor: Krishna Mohan, Naperville, IL (US)

Correspondence Address: Mr. Krishna Mohan, 3528 Breitwieser Lane, Naperville, IL, 60564, US

(21) Appl. No.: 10/763,991

(22) Filed: Jan. 22, 2004

(51) Int. Cl. G06F 17/60

(52) U.S. Cl. 705/26

(57) ABSTRACT

A method, apparatus and computer programs for gathering data from business transactions conducted at a point of sale using a portable memory device, like, a removable USB flash memory drive. A customer gathers a plurality of a transaction and electronic receipt files by connecting the portable memory to a computer at the point of sale. Over a period of time, the customer consolidates the files into a second database. In one embodiment, the vendor reads an identification data of the customer from the portable memory and stores in a first database along with business transaction data. In another embodiment, the vendor searches for the electronic receipt in the portable memory for matching product identifier of a returned product to complete a return transaction. The apparatus comprises a portable memory connector with a connecting means for the customer to attach and detach the portable memory at the point of sale.

### CROSS-REFERENCE TO RELATED APPLICATIONS

Not Applicable.

### STATEMENT REGARDING FEDERALLY SPONSORED RESEARCH OR DEVELOPMENT

Not Applicable.

SEQUENCE LISTING OR PROGRAM

Not Applicable.

### BACKGROUND OF THE INVENTION

1. Field of the Invention

The present invention, in its broader aspect, relates to a data gathering method and particularly to a method of computer data gathering of business transactions conducted at a point of sale, using a portable memory device.

2. Background of the Invention

Computer data gathering of business transactions conducted at a Point Of Sale (POS) between a customer (buyer) and a vendor (seller), typically involves, a customer collecting paper receipts and manually entering the data from each paper receipt into a personal finance management or business finance management software system. The customer may also manually scan each of the paper receipt into a document management system or an enterprise content management system to digitally store and organize the paper receipts.

The current way of manual data gathering of point of sale business transactions is time consuming and error prone. There are many software systems or products that consume such data, for example, personal finance management software products, business finance software products, document management systems that are used to electronically organize paper receipts and enterprise content management systems. These systems help the customer, only if, the data is entered into those systems correctly. For many individuals, household entities and business entities, business transaction data corresponding to transactions conducted at a point of sale is a major portion of the data that need to be entered into such software products or systems. The customer may have more than one user conducting such point of sale business transactions, as in the case of a household entity or a business entity. In such cases, manual approach to gather and consolidate data from paper receipts into such systems becomes further difficult, time consuming, labor intensive and expensive; in addition to inconvenience and errors that the customer may have in keeping track and organizing those paper receipts. Without proper data entry and/or data quality, the benefits of aforementioned systems diminish drastically.

Data entered from paper receipts into the aforementioned software systems typically lack the granularity of details that may be available in the corresponding paper receipt, due to, the customer may not have time or resources to enter the data in a detailed granularity. For example, a small business may have brought several office supply items on a regular basis from several stores by conducting the business transaction at a point of sale. The small business may be entering data from the paper receipts into business finance management software, for example, the QuickBooks from Intuit, Inc, under the expense category called “Office Supplies”. The small business may not be entering all the information that may be available in the paper receipt, for example, amount spent on each individual office supply item and the like, even though, the small business may be purchasing those individual office items frequently. This may cause the small business, a lost opportunity to benefit from business intelligence associated with detailed reports that may be generated with such detailed data entry. This situation becomes further difficult when there are several employees within a business or more than one individual in a household conducting business transactions at a point of sale, which is typically the case. These limitations have reduced the customer from fully benefiting from aforementioned software systems. For example, a household entity may try to organize personal finance using a personal finance management software product, for example, by using, well known Microsoft money or Quicken. But over a period of time, may not be able to keep track and organize paper receipts and may give up the effort; or the quality of data in such software system may go down due to missed data entry and/or manual data entry errors.

Another common requirement on the part of a customer is to maintain paper receipts of point of sale business transactions. For example, a business entity may need to maintain the paper receipts for tax purposes and other legal purposes; an individual customer may maintain the receipts for other reasons, like, a warranty claim. There are several document management systems available in the art to allow digitizing these receipts and storing them electronically for quickly locating and sharing them with users. Examples of such paper receipt document management software may include PaperPort from ScanSoft, Inc, Adobe Acrobat from Adobe, Inc., and the like. Large businesses may use enterprise content management systems (ECM), for example, FileNet ECM from Filenet Corporation. Even though, these systems have helped the customer to better organize paper receipts, still, they require manual scanning of the paper receipts into those systems. Manually scanning of receipts on a regular basis is again labor intensive, expensive and error prone. Moreover, customers may easily lose or misplace paper receipts.

Some credit cards, for example, American express card, allows the customer to make purchases using the card and provide statement of the transactions by categories on a regular basis like, monthly, quarterly, etc. These statements can be downloaded into a computer and into personal or business finance management applications from a web site of the credit card company. Even though such cards have helped data gathering process to some extent, they still have several drawbacks. They force the customer to use one type of payment method and a specific card, eliminating the freedom of choosing preferred payment method by the customer. Some vendors may not accept a certain type of credit card and still in many cases, customer may prefer to use cash, check or debit card. Moreover, details provided by those credit card statements are not very detailed and lacks granularity. For example, a restaurant business may want to track how much they are spending on vegetables, cooking oil etc, which all come under one category called “groceries”. Credit card statement may only contain total amount spent on groceries, listed by transaction on each date, but may not contain details within each transaction. In addition to this, such credit card statements are available only on monthly, quarterly or even on a yearly basis and customer need to wait that long to receive statements from the credit card company. Such statements may not be available on a daily or weekly basis, due to, cost associated with data processing to a credit card company or other reasons. In addition to this, credit card companies do not maintain electronic receipts for each transaction, for example, computer image representation of a paper receipt, which may be required by several customers, leaving the customer with manual scanning of each receipt in order to convert and store them electronically.

Accordingly, on the part of a customer, there is a need exists in the art for an improved method of data gathering related to business transactions conducted with vendors at a point of sale to eliminate or reduce the manual effort of data entry and scanning of receipts and to remedy other aforementioned disadvantages.

On the other hand, vendors (sellers) may want to identify a customer at a point of sale and collect the data associated with business transactions conducted by the customers, for the purposes of identifying frequent customers, to conduct market research, identify buying patterns, to reward and retain frequent customers and the like. Typically, a vendor collects these data by requesting customers to participate in a frequent customer program. This process typically involves collecting personal information from a customer and assigning a customer identification number. Even though this approach has provided the vendor to gather business transaction data of customers, this approach has several drawbacks. Customers need to maintain such accounts with each vendor, and customers may refuse to participate in each program and may not be willing to provide personal information or spend time and effort to complete the forms.

Accordingly, there is a need exists in the art for an improved method for identifying frequent customers by a vendor for business transactions conducted at a point of sale, without the customer having to provide personal information or having to maintain several accounts with vendors.

On another note, product returns by a customer to a vendor, typically, requires the customer to present the receipt of original purchase during a return transaction. The customer may have misplaced or may not have the receipt readily available during the return transaction. Even with the receipt, an employee of the vendor need to eyeball the receipt and identify the return purchased item in the receipt. Accordingly, there is a need exists in the art to improve this process.

The present invention discloses a novel and innovative method of using portable memory device to gather business transaction data conducted at a point of sale, which is mutually beneficial to both of a customer and a vendor and facilitates the data gathering by both of the customer and the vendor using a common approach.

Other advantages of the present invention are readily apparent to one of skill in the art from the attached figures, detailed description and claims.

### BRIEF SUMMARY AND OBJECTS OF THE INVENTION

In accordance with the present invention, a method for gathering of business transaction related data, conducted at a point of sale, between a customer and a vendor, using a portable memory device, for example, a removable USB flash memory drive, that substantially eliminate or reduce aforementioned disadvantages, is disclosed. In order to practice the method of present invention, an apparatus for attaching and detaching the portable memory device at the point of sale, and descriptions of various computer programs that implement the method is also disclosed.

According to one embodiment of the present invention, a customer selects one or more portable memory devices for the purpose of point of sale business transaction data collection and provides the portable memory device to each user, representing the customer. If the customer is an individual, a single portable memory may be used. The customer creates a device configuration file in the portable memory device, and within the file creates a first data parameter with a customer identification data that uniquely identifies the customer to a vendor. The customer may also create unique user identification data in a second data parameter within the device configuration file. The customer (or the user representing the customer) enters into a business transaction with the vendor at a point of sale, and provides, and connects the portable memory device to a first computer system used by the vendor. The vendor receives a set of data corresponding to the business transaction from a data processing system, and using the set of data, prepares and creates a transaction data file and electronic receipt file in the portable memory device. For example, the transaction data file may contain the details of the business transaction in XML format and the electronic receipt file may be a computer image representation of the paper receipt of the business transaction. During this process, the vendor may read the customer identification data from the device configuration file in the attached portable memory device and associates the customer identification data with business transaction data and stores in a first database, which may be used to identify and reward frequent customers. At the end of the business transaction, the customer detaches the portable memory and receives it back. Over a period of time, the customer gathers the transaction data files and electronic receipt files in the portable memory device from a plurality of vendors, corresponding to a plurality of point of sale business transactions. Similarly, the vendor receives the portable memory devices from a plurality of customers, contributing to the data stored in the first database. At certain intervals or over a period of time, the customer attaches the portable memory device to a computer used by the customer and consolidates the transaction data files and electronic receipt files into a second database.

In another aspect of the present invention, a customer returns one or more purchased items to a vendor and provides the portable memory device to the vendor. The vendor receives the purchased item identification, for example, by scanning the barcode of a product code and a serial number of the returned purchased item. Then the portable memory device is searched for transaction data and electronic receipt files that having the purchased item identification in the file data contents; If found, the contents of the transaction data and/or electronic receipt files are displayed to the vendor to complete the return transaction without a paper receipt.

Yet another aspect of the present invention is to provide an apparatus to conveniently attach and detach a portable memory device to/from a computer system of a vendor, by a customer, at a point of sale, without human assistance from the vendor. The apparatus comprises a portable memory connector and a first connecting means to connect the portable memory connector to a computer system used by the vendor at the point of sale. The portable memory connector needs to be placed in a convenient position in a location of the point of sale, such that the customer conducting the business transaction at the point of sale can easily attach and detach the portable memory device. The location of the point of sale may be a self-service terminal, for example, an automated checkout counter that are commonly found in super markets and department stores. The apparatus allows the customer to practice the method of present invention at automated point of sale counters.

It is an object of the present invention to eliminate or reduce the manual effort and cost involved in data gathering related to point of sale business transactions, and to provide less time consuming and more automated method of point of sale business transaction data gathering using a portable memory device.

It is yet another object of the present invention to allow the customer to gather business transaction data with detailed granularity, thus, to improve the quality of the data, without the customer having to manually enter all such details. Therefore, enabling the customer to benefit from business intelligence associated with such data, which may be utilized, by using the present invention in association with useful computer applications that may use such data.

It is one more object of the present invention to allow the customer to organize electronic version of paper receipts related to business transactions, without manual scanning of the paper receipts into a document management software system or an enterprise content management system.

It is yet one more object of the invention to allow multiple members of a household or a business entity to participate in data gathering process by using a portable memory device per each member such that collected data from each portable memory device can be easily aggregated and centralized under a specific entity.

It is yet another object of the present invention to allow a vendor to identify and reward frequent customers by using a customer identification data found in a portable memory device as unique customer identification, thus facilitating association of business transactions data with a specific customer.

It is yet one more object of the present invention to allow a customer to use a single portable memory device with a plurality of vendors in order to participate and benefit from frequent customer programs, without having to establish separate account with each vendor.

It is one more object of the present invention to allow customers to participate in frequent customer programs with vendors, without having to disclose personal information, and in a manner that protects the privacy and confidence of the customer, by identifying themselves using a data value in a device configuration file stored in the portable memory device, which can be controlled by the customer.

It is one more object of the present invention to allow the vendor to award frequent customers by writing business promotion data files in a portable memory device, which a customer may browse during leisure and learn more details about the promotion and/or, when clicked on a hyperlink in the business promotion data file in a HTML format, allows the customer to participate in such promotions in the vendor's web site, thus providing a new method of generating additional sales for the vendor using the portable memory device.

It is another object of the present invention to provide a method of using a portable memory device to return purchased items to a vendor, without providing the paper receipt of the original purchase to the vendor.

Further, it is yet another object of the present invention to disclose a novel and yet another use of a portable memory device.

A major advantage and feature of the present invention is that it provides a method that uses a portable memory device to enable point of sale business transaction data gathering by both of a customer and a vendor by providing a common approach.

Still further objects and advantages will become apparent from a consideration of the ensuing detailed description and drawings.

### BRIEF DESCRIPTION OF THE DRAWINGS

For a more complete understanding of the present invention, and for further features and advantages thereof, reference is now made to the following description taken in conjunction with the accompanying drawings, wherein, like reference numbers represent corresponding parts throughout, in which:

FIG. 1 is a diagram that shows few types of exemplary portable memory devices that may be used to practice the present invention;

FIG. 2 is a block diagram of generic computer system that may be used by a vendor and a customer to practice the current invention;

FIG. 3 is a data flow diagram illustrating the business transaction data gathering method, used by a vendor and a customer, by using a portable memory device at a point of sale, in accordance with the teachings of the present invention;

FIG. 4 is a data flow diagram, further illustrating the data gathering method by a customer, which is specified in FIG. 3;

FIG. 5 is a data flow diagram illustrating the method of returning one or more purchased items to a vendor, using a portable memory device;

FIG. 6 is a block diagram illustrating the exemplary file contents of a portable memory device of a customer, after practicing the data gathering method of the present invention;

FIG. 7 illustrate block diagram of an exemplary device configuration file contents, in accordance with the teachings of the present invention;

FIG. 8 illustrate a diagram that shows exemplary contents of a transaction data file that is created in a portable memory device of a customer, by a vendor, in XML format, during a point of sale business transaction;

FIG. 9 illustrate a block diagram of an exemplary system used by a vendor to practice the teachings of the present invention;

FIG. 10 illustrate a block diagram of an exemplary system used by a customer to practice the teachings of the present invention; and

FIG. 11 illustrate one embodiment of an apparatus of the present invention that is used to conveniently attach and detach a portable memory device at a point of sale, by a customer.

### DETAILED DESCRIPTION

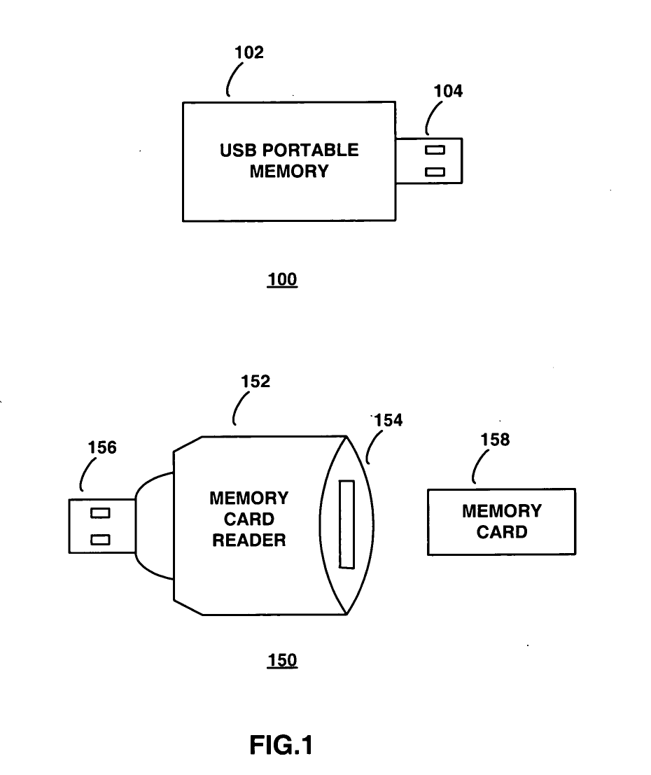

Referring now to FIG. 1, 100 and 158 are few exemplary portable memory devices that may be used to practice the current invention. This invention refers such and similar devices as “portable memory devices” or “portable memory”. Universal serial bus (USB) removable memory 100 comprises a memory unit 102 with USB port connector 104. These devices sometimes referred to as “key chain” memory devices or plug-and-play memory devices. These devices are becoming increasingly popular due to affordability, portability and amount of data they may carry and have become a class of indispensable peripherals that are widely utilized by computer users. In fact, these devices can be easily carried in a key chain or in a wallet. These devices are generally not permanently fitted to a computing platform, such as a personal computer. Rather they can be conveniently attached to and removed from any computing device having the appropriate connection port (e.g. a serial bus port like a USB port, or IEEE 1394 or “Firewire” port). Memory cards are another popular portable memory devices. These cards do not have a port connector like a USB removable memory. As shown in 150, memory card 158 can exchange data files from a computing device, like a personal computer, using a memory card reader 152. A memory card reader 152 has a slot 154 to conveniently attach and remove a memory card 158, and a port connector, like, a USB port connector 156 on another end. When attached, an operating system of the computer (e.g. Microsoft Windows XP) supporting plug-and-play architecture can detect the portable memory device automatically and can treat the memory device, as if, it resides on the computer system. User can easily transfer files to and from the memory device, and when done, can eject or detach the memory device and easily carry along.

This invention discloses a novel method of using such portable memory devices to gather point of sale business transaction data that can be used by both customers and vendors. A point of sale can be a human assisted checkout counters that are commonly seen in super markets and department stores or totally automated self-service checkout counters or kiosks, automatic vending machines and automatic teller machines. Typically, a customer conducts a business transaction with a vendor at the point of sale and receives a paper receipt. The customer referred in this invention may be an individual or an entity represented by more than one user, for example, a household entity with several family members, a business entity or government agency with multiple employees. This invention uses the word “vendor” for any business or government entity that may sell products and/or services at a point of sale. The business transaction conducted at the point of sale may be a purchase or return of purchased items. A vendor may be also referred as a seller and a customer may be also referred as a buyer.

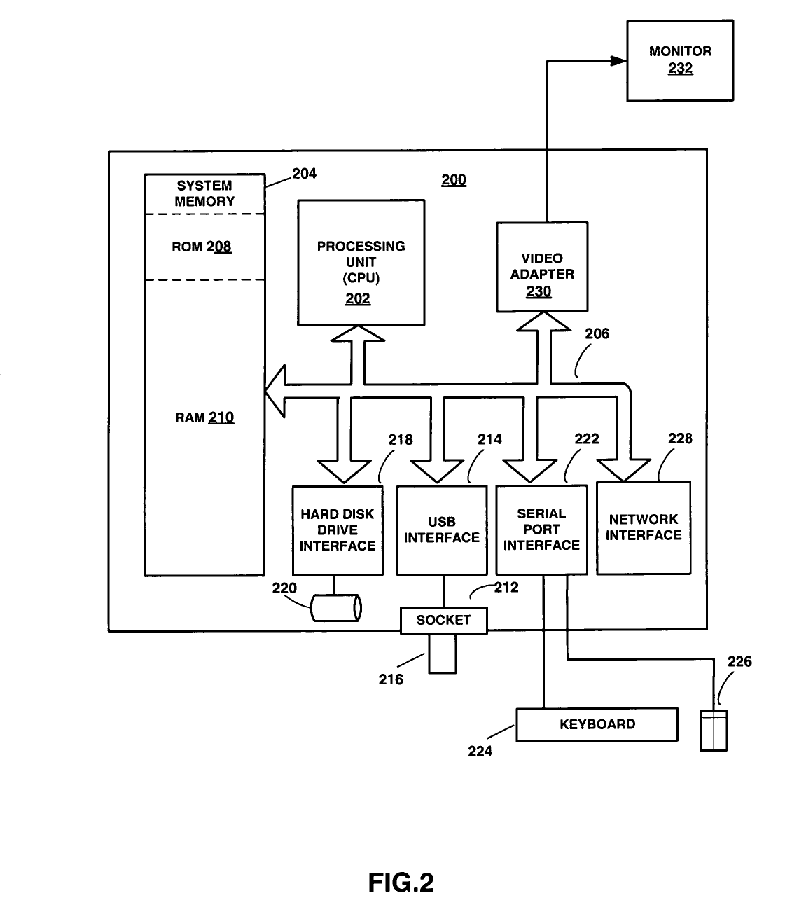

FIG. 2 and the following discussion are intended to provide a brief, general description of a suitable generic computing environment in which the invention may be implemented by both of a customer and a vendor. With reference to FIG. 2, an exemplary system for implementing the invention includes a generic computing device in the form of a conventional computer 200, including at least one processing unit or CPU 202, a system memory 204, and a system bus 206 that couples various system components including the system memory 204 to the processing unit 202. The system bus 206 may be any of several types of bus structures including a memory bus or memory controller, a peripheral bus, and a local bus using any of a variety of bus architectures. As is known by one skilled in the art, the system memory 204 may include read only memory (ROM) 208 and random access memory (RAM) 210. Furthermore, a basic input/output system (BIOS), containing the basic routines that help transfer information between elements within computer 200, such as during start-up, may be stored in the ROM 208. With respect to the RAM 210, various operating systems, application programs, program data, and other program modules may be stored therein, as commonly known by one skilled in the art. The computer 200 may include several data ports like USB, IEEE 1394 (“firewire”), etc. A USB data port socket is shown in this illustration by 212 and is connected to the system bus by USB interface 214. A portable memory device 216 with a USB connector can be easily attached to and detached from the computer 200. A computing device may also include various drive interfaces that are capable of reading different data media. For example, computer 200 may include a magnetic hard disk drive interface 218 for reading from and writing to a magnetic hard disk 220. The drives and their associated computer-readable media provide nonvolatile storage of computer-executable instructions, data structures, program modules and other data for the computer 200. A serial port interface 222 connects user interaction devices, like a keyboard 224 and mouse 226 to the system bus. In a point of sale computer system, this keyboard may correspond to a keypad located in a self-service terminal. A network interface 228 may be used to connect the computer 200 to other computers using a communications network. Video adapter 230 connects the monitor 232 to the system bus. In a point of sale (POS) computer system, this monitor may be a display unit of a self-service terminal. The point of sale computer may have additional peripheral devices, for example, bar code scanners and receipt printers connected to the computer.

Those skilled in the art will appreciate that the invention may be practiced in environments with many types of computer system configurations, including personal computers, point of sale (POS) computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices or computer readable mediums.

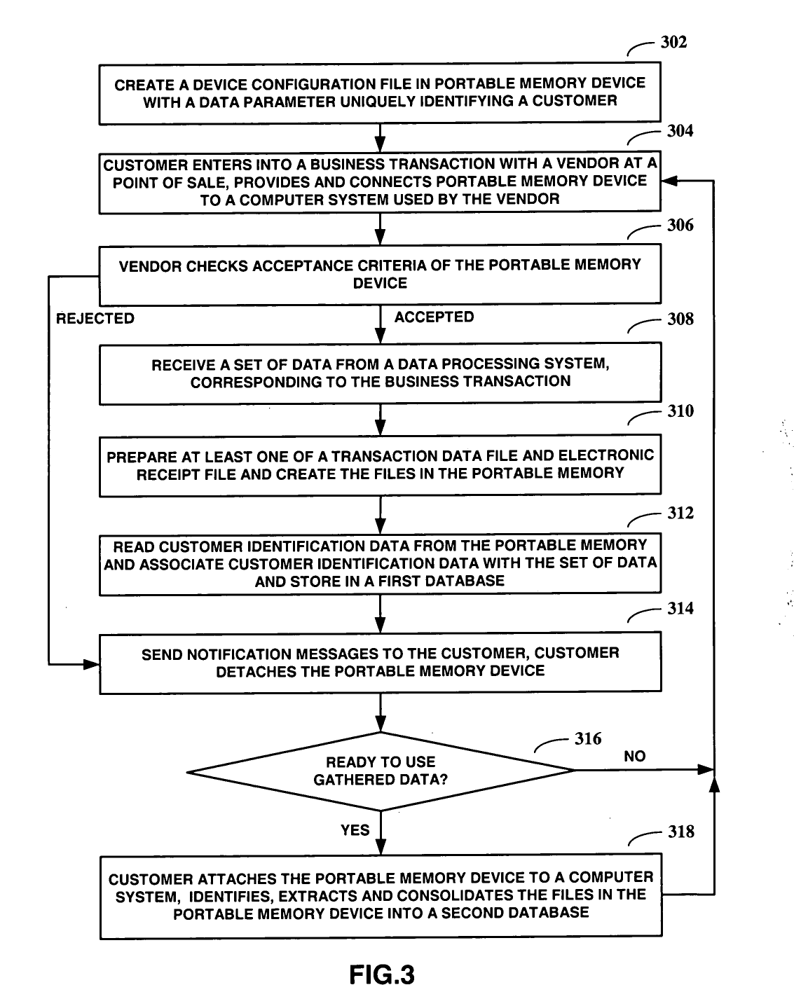

FIG. 3 depicts a flow diagram of a business transaction data gathering method using a portable memory device for business transactions conducted between a customer and a vendor at a point of sale. In one embodiment, the method starts at step 302 by the customer choosing a portable memory device for business transaction data gathering purpose and creating a device configuration file in the portable memory, in which, one of the data parameter uniquely identifies the customer. The customer may also create unique user identification data in the device configuration file of each of the portable memory device, in a multi-user environment. The customer may also create several data parameters in the device configuration file, which is detailed in next sections.

At step 304, the customer enters into a business transaction with the vendor at the point of sale and connects the portable memory device to a first computer system used by the vendor. During the business transaction, a message may be displayed on a display unit of the computer system, asking whether the customer would like to use the portable memory device. If the answer is in the affirmative, the customer may connect the portable memory device to the first computer system, either by handing over the portable memory to an employee of the vendor at the point of sale, or by using a connecting apparatus, which is described in later sections. In one embodiment, the connecting apparatus may have a USB socket with a socket case, conveniently located in a position accessible by the customer at the point of sale so that the customer can attach and detach the portable memory with USB connector, to and from the first computer system without any human assistance from the vendor.

At step 306, the vendor checks for acceptance criteria of the portable memory device. In one embodiment, the vendor checks for existence of harmful computer files in the device. This may be a “computer virus” scan performed on the device. The vendor may also check whether unique customer identification data exists in a device configuration file in the portable memory. It should be noted that creating the unique customer identification data in the portable memory by the customer is optional. However, it provides a novel opportunity for the vendor to identify frequent customers and allows the vendor to gather business transactions data from a plurality of customers with customer identification. The customer need not disclose any personal information, for example, name, address, social security number, etc., since the vendor identifies customer by unique data value, for example, a number or combination of characters. In exchange for providing business transaction files to the portable memory device that enables the customer to automate data gathering process, the vendor can tap this opportunity to gather valuable customer data that may be used for identifying and rewarding frequent customers and/or to conduct product or market research. This creates a mutually beneficial environment for both customers and vendors.

If the outcome from the acceptance criteria 306 is in the negative, the vendor may reject the device and disconnect the portable memory from an operating system executing on the first computer system and notify the customer to detach the portable memory device. In one embodiment, a notification message requesting the customer to detach the portable memory may be sent to a display unit of a self-service terminal at the point of sale. The vendor is provided with a first computer program with a plurality of code sections to implement and automate some of the steps of the method.

If the acceptance criteria are satisfied, vendor accepts the portable memory and process moves to step 308. At this step, the first computer program receives a set of data from a data processing system of the vendor. In one embodiment, this is the point of sale data processing system used by the vendor to process business transactions at the point of sale. The set of data may have one or more data elements corresponding to the business transaction. In one embodiment, the set of data may have all of the information that may be found in a paper receipt of the business transaction. The set of data may be in the form of a data structure residing in the random access memory of the first computer system or in the form of a data file residing in a non-volatile storage media of the first computer system. The set of data may also comprise a transaction category, vendor category and an item category corresponding to each purchased item of the business transaction.

At next step 310, the vendor prepares and creates at least one of a transaction data file and an electronic receipt file in the attached portable memory, using the set of data received from the data processing system. Throughout this description of the present invention, the term “file” or “data file” refers generally to any arrangement or organization of the information that may be generated, modified or accessed by the methods described herein. One of the data elements of the set of data may be a computer image representation of corresponding paper receipt of the business transaction. In one embodiment, the transaction data file may be in an extensible manipulation language (XML) format and the electronic receipt file is in a well-known computer image format, for example, JPEG format. The transaction data file can be read by a personal finance management software or business finance management software in a computer system used by the customer, whereas, the electronic receipt file can be read by a document management system and an enterprise content management system.

It should be noted that, the vendor might write the transaction data file and electronic receipt file in multiple data formats. For example, the vendor may write the transaction data file in a XML format, a comma delimited format or in a format that is specific to a software application product, for example, in a file format that is specific to a personal or business finance management software product. The vendor may write same electronic receipt file in more than one computer image format, like, bitmap format or in a software application product specific format, for example, in a PDF format, that is viewable using the well-known Adobe Acrobat reader.

According to one embodiment of this method, all vendors will be using a standard file naming convention to write transaction data files and electronic receipt files in the portable memory device. For example, a file name pattern “TRANSDATA_<VendorName>_<MainCategory>_<TimeStamp>.xml” may be used. If the customer conducted a business transaction in a store by name STOREMART, which is a general grocery store, a transaction data file may look like,
“TRANSDATA_STOREMART_GROCERY_{—}20040112151602.xml”.
   Similarly, the electronic receipt file corresponding to above transaction may look like,
“ERECEIPT_STOREMART_GROCERY_{—}2004012151602.jpeg”.
   Over a period of time, the customer may be conducting several such point of sale business transactions with multiple vendors and receives a plurality of transaction data files and electronic receipt files in the portable memory device. Using the consistent file naming convention across all of the vendors makes it possible for the customer to consolidate the transaction data files and electronic receipt files from the portable memory device into another application or into a database, by using a consistent file identification pattern, which can be automated.

In another embodiment, the vendor may use a data content pattern within the transaction data files and electronic receipt files. For example, some vendors may write a header record with unique data pattern, using which the customer may identify the transaction data file and the electronic receipt files.

At step 312, the vendor reads the device configuration file in the portable memory device and extracts the unique customer identification data. The device configuration file may have a fixed name or a file name pattern that is known to the vendor and, by using the first computer program, the vendor reads, parses and extracts the unique customer identification data of the customer. Next, the vendor associates unique customer identification data with one or more data elements from the set of data and stores in a first database. In one embodiment, the vendor may store unique customer identification data with data elements, for example, total amount of the transaction, category of items purchased and creates a record in the first database with unique customer identification. Over the time, the vendor may receive such portable memory devices from a plurality of customers, thus, enabling the vendor to build a frequent customer database. The vendor may use this database to identify and reward frequent customers, or to conduct market or a specific product research, while maintaining the privacy of the customer, since the customer is represented by an identification number without any reference to personal information. The vendor implements this step by using the first computer program.

In yet another embodiment, in addition to preparing and creating the transaction data file and electronic receipt file, the vendor may check for any business promotions available for the frequent customer, by checking a buying pattern of the customer from the data available in the first database. If the customer is eligible for any promotions, the vendor may notify the customer in various ways. The vendor may display business promotion related messages on a display unit, visible to at least one of the vendor or the customer, and may provide an instant discount to award the frequent customer. The vendor may also write one more file into the portable memory device, called a business promotion file. For example, the business promotion file may be in a hypertext manipulation language format (HTML) and provides more details about the promotion and a hyperlink to the vendor's website to allow the customer to participate in such promotions. This will allow the vendor to generate additional sales while rewarding the frequent customer. The customer may browse the portable memory during leisure and may participate in such business promotions. The customer may also indicate that she or he is not interested in receiving such files by creating a parameter in the device configuration file, which may be read by the vendor during the business transaction.

Next, at step 314, the vendor disconnects the portable memory device from the operating system executing in the first computer system. For example, in Microsoft Windows XP operating system, this is equivalent to ejecting a plug-and-play hardware device. Next, the customer is notified to detach or physically remove the portable memory device connected to the first computer system. In one embodiment, the first computer program may display a message like “Data files transferred to the portable memory successfully. Please remove the portable memory”, or “Harmful files detected in the portable memory device. We cannot provide this service at this time. Please remove the portable memory device”, or “Not enough space available in the portable memory device. Please remove the portable memory device”, or “We require a customer identification in the portable memory to provide this service. For more details, please contact our customer service”, etc.

At step 316, the customer can make a choice of whether she or he has collected enough transaction data files and/or electronic receipt files in the portable memory device to start the extraction and/or consolidation process. If the customer is not ready, they can go back to step 304 and collect more files from other point of sale business transactions. If the customer decides to extract and/or consolidate the files, process moves to next step 318.

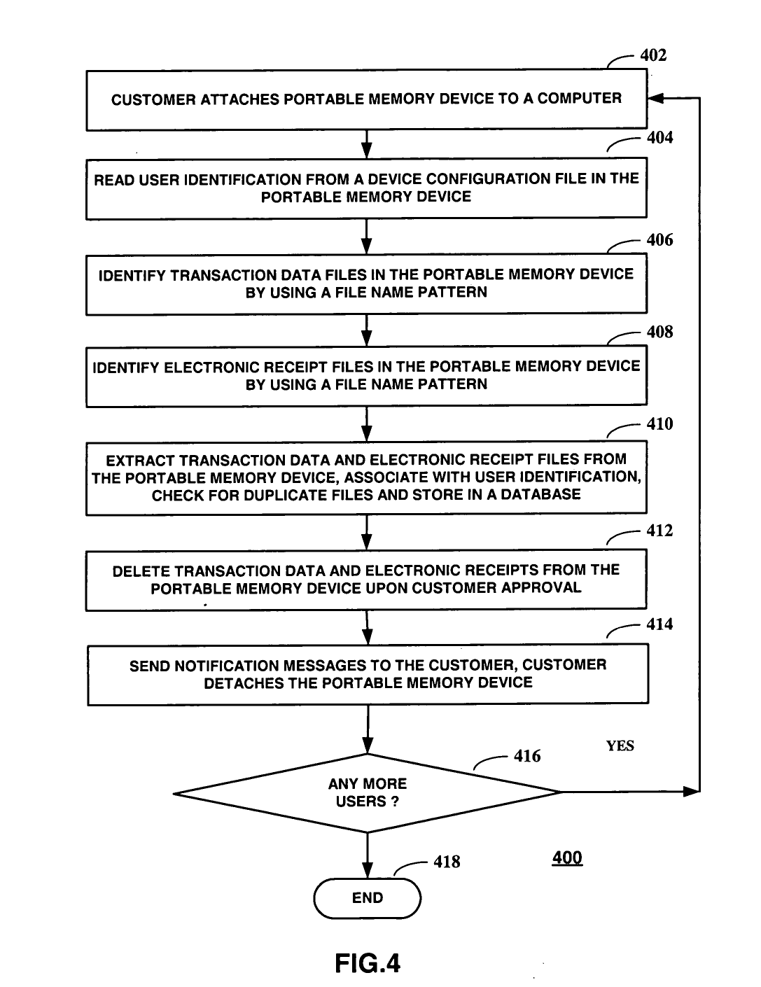

At step 318, the customer attaches the portable memory device to a second computer system used by the customer and identifies and extracts the transaction data files and/or electronic receipt files into a second database. This step of the method is implemented by providing a second computer program to the customer, executable on the second computer system. The step 318 also performs various data management activities on the gathered data by using the second computer program. After successful extraction of the data files, the transaction data files and/or electronic receipt files are archived in the second computer system and deleted from portable memory device, based on the customer choice. This step is described in more detail with reference to FIG. 4. Once the customer extracts the data files into the second database, same portable memory device can be used again for gathering next batch of point of sale business transaction data by going back to the step 304.

It should be noted that various modifications to above method, without departing from the scope of the present invention are possible. For example, data gathering by vendor and by customer using the portable memory device can be independent and not necessarily depend upon each other. Some vendors may be willing to create transaction data and electronic receipt files, without the customer having to provide the customer identification data in the device configuration file. These vendors may provide this service at a point of sale, simply as an additional customer service. Similarly, some customers may use the portable memory device with few vendors, just to participate in the frequent customer program.

Now referring to FIG. 4, a more detailed flow diagram of step 318 of FIG. 3, in accordance with one embodiment of the present invention. FIG. 4 depicts a data gathering method 400 by the customer. After collecting a plurality of transaction data and/or electronic receipt files, a customer may decide to extract and/or consolidate the files by connecting the portable memory device to a computer used by the customer and is represented by step 402. This computer system is also referred in this invention as a second computer system, in order to distinguish it from the first computer system used by a vendor. At step 404, the second computer program reads the device configuration file from the portable memory device and extracts user identification. This step is useful in a multi-user environment to associate data with appropriate user in the second database. In case, if the device configuration file or user identification is not found, it will be assumed that the customer is an individual user and the data may be associated with a default user id or no user id at all.

In one embodiment, at step 406, a computer-implemented search is made in the file system of the portable memory device for all transaction data files using a pre-determined file name pattern or patterns, for example, all files matching with “TRANSDATA*.xml”, and a list of identified transaction data files that need to be extracted will be prepared. In another embodiment, the search may be made in the portable memory device for files with certain pre-determined data content pattern to identify the transaction data files. At step 408, a computer-implemented search is made in the file system of the portable memory device for all electronic receipt files using a pre-determined file name pattern. For example, all files matching “ERECIPT*.jpeg”, and a list of identified electronic receipt files that need to be extracted will be prepared. These searches will be implemented using the second computer program.

At step 410, the identified transaction and/or electronic receipt files will be extracted and/or consolidated into the second database along with the user identification, if appropriate, thus, relieving the customer from having to manually enter or scan the paper receipts. During this step, various data management activities may be performed. For example, a check may be made for duplicate files. During this step, some data conversion activities also may be performed. For example, categories from the transaction data file in XML format may be mapped to corresponding category in the personal or business finance management software system. This process may be performed totally without the customer intervention, or with minimal intervention, wherever applicable. For example, a duplicate file may be found and the second computer program may display a message requesting the user input as to overwrite the previous data or to ignore it. The database or a second database may be a stand-alone database, for example, a relational database, a hierarchical or object oriented database, or may be collection of several files. The second database may be part of a personal or business finance management system database; or part of a document management or enterprise content management system database.

In another embodiment, a personal or business finance management product may use the steps of the method 400 to reduce manual data entry process and may include the present invention in such products. For example, such products may provide additional user menu items, like, “extract from portable memory” and various other menus and user interface for setting file name patterns and mapping transaction data file categories to personal or business finance categories, etc. When the customer selects “extract from portable memory” menu option, the personal or business finance management product, executing on a computer system of the customer, may automatically identify and extract the transaction data files in the attached portable memory and consolidate them into the database maintained by such products or systems.

Similarly, a document management system, or electronic paper receipt organization system and/or an enterprise content management (ECM) product may use the steps of the method 400 in such products or systems. For example, such products may have an additional menu item, for example, “extract from portable memory” and other related menu settings. When the customer clicks on this menu, such systems or products can automatically extract all matching electronic receipt files, which may be in a computer image format, along with corresponding transaction data files in XML format; which enable such systems or products to automatically create the categories and assign appropriate electronic receipt file in a computer image format under such categories. This approach built into such products, will save tremendous amount of time on the part of the customer, which otherwise needs manual scanning of paper receipts.

After successful extraction of the files, at step 412, the customer may chose to delete the data files from the portable memory device. However, if the customer decides to keep the files in the portable memory for some other purposes, these files may be renamed with a file extension to identify that they are already processed. For example, these files may be renamed with an additional file extension, for example, as “.read”. At step 414, the customer is requested to detach the portable memory device and any other processing related messages would be displayed to the customer.

It should be noted that, a customer may have multiple users and the customer may provide a portable memory device for data gathering purposes to all or few of the users. At step 418, the customer is asked whether any more users are there in the current batch of data gathering. If there are any more users, the process goes back to step 402 to attach another portable memory device from other user. If there are no more users, the process ends at step 418.

The above steps can be used by a business or government entity to perform routine data gathering from several employees. For example, the business entity may use above method for processing travel expenses from various employees on a weekly or monthly basis. In one embodiment, the business entity may provide a portable memory device to each of its employees, who may travel frequently. Each employee may provide the portable memory device to gather data files from various point of sale business transactions that the employee may conduct during the business travel. For example, the employee may gather transaction data and electronic receipt files from hotels, restaurants, and car rentals, etc. On a weekly basis, each employee may submit the portable memory device to the human resource department of the business entity. The human resource department may consolidate these files from the portable memory devices, directly into an enterprise content management system by using the teachings of the present invention. This will eliminate or reduce the effort from the employees for submitting the travel expenses, whereas, the business customer gains from better-managed and well-documented travel expense management, in addition to, better audit process and reduced overall cost.

In another application of the present invention, a small restaurant business may be doing various point of sale purchases on a daily basis and may use the method of current invention. The small restaurant business may have more than one buyer conducting the point of sale business transactions, each having a portable memory device for data gathering purpose. For example, the restaurant business may purchase various types of vegetables, dairy products, cooking oil, cleaning products etc. At the end of the day or a week, the small restaurant business would have conducted several point of sale business transactions and received several transaction data and electronic receipt file in each of the portable memory device. Now using the method 400, the business easily extracts and consolidates the files from each of the portable memory device into the second database or into a business finance management software, for example, QuickBooks from Intuit, Inc. It's apparent that in addition to reducing manual efforts, the quality and granularity of the data is also improved. The small restaurant business may utilize this data to identify money spent on each specific product or service and can use this information for their benefit.

In another embodiment, a third computer program is provided in the portable memory device. The third computer program automatically starts executing when the customer attaches the portable memory device to the second computer system and checks whether a second computer program is already executing. If not, it may start the second computer program in the second computer system. If it cannot locate the second computer program, it may simply terminate. In Microsoft Windows operating system environment, this third computer program is a file of type “Autorun.inf”, that is commonly used to automatically install the computer applications from a computer readable medium like a CD ROM. Typically, the third computer program will contain few lines of instructions that can be understood by the operating system and are commonly called as operating system specific scripts. The third computer program notifies the second computer program to automatically identify and extract the transaction data and electronic receipt files from the portable memory device into the second database or into other applications. This embodiment provides an additional layer of automation. The customer only needs to attach the portable memory device. When extraction of the data files is complete, the second program may automatically disconnect the portable memory device by interfacing with the operating system application programming interface (API) and may notify the customer to detach the portable memory device from the second computer system.

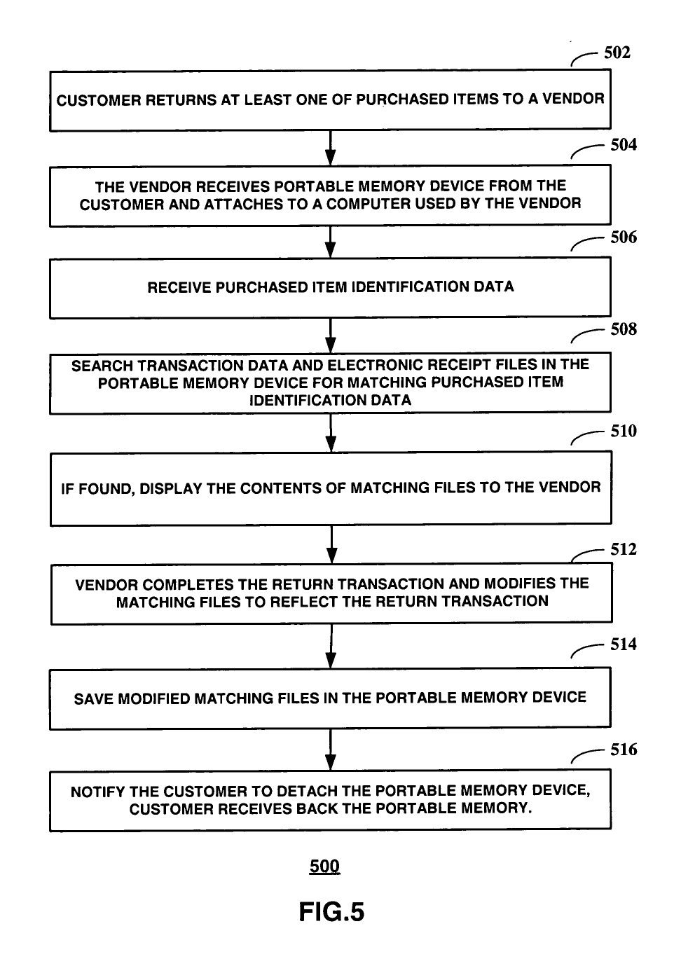

Now, referring to FIG. 5, illustrative of a method 500 of returning one or more purchased items to a vendor using a portable memory device. A customer may have gathered transaction data and electronic receipt files corresponding to the original purchase in the portable memory device. In one embodiment, at step 502, the customer returns one or more of the purchased items by returning them at a customer service center desk of the vendor. At step 504, the customer provides the portable memory to the vendor and connects the portable memory to a computer used by the vendor. At step 506, purchased item identification is received. For example, this may be by means of the vendor scanning the bar coded universal product code (UPC) identifier and serial number from the purchased item box. At step 508, a computer-implemented search is made in the portable memory device to identify transaction data and electronic receipt files that having the matching purchased item identification data. At step 510, if found, at least one of the transaction data files and/or electronic receipt files will be displayed to the vendor on a display unit of the computer. The vendor can use these files to complete the return transaction. At step 512, the vendor modifies these files in the portable memory device to reflect the return transaction. At step 514, the modified files are saved in the portable memory device. At step 516, the customer is notified to detach the portable memory and receives the portable memory back. Using this method, the customer can return purchased items without having to organize and maintain corresponding paper receipts. The purchased items may be a purchased product or a purchased service.

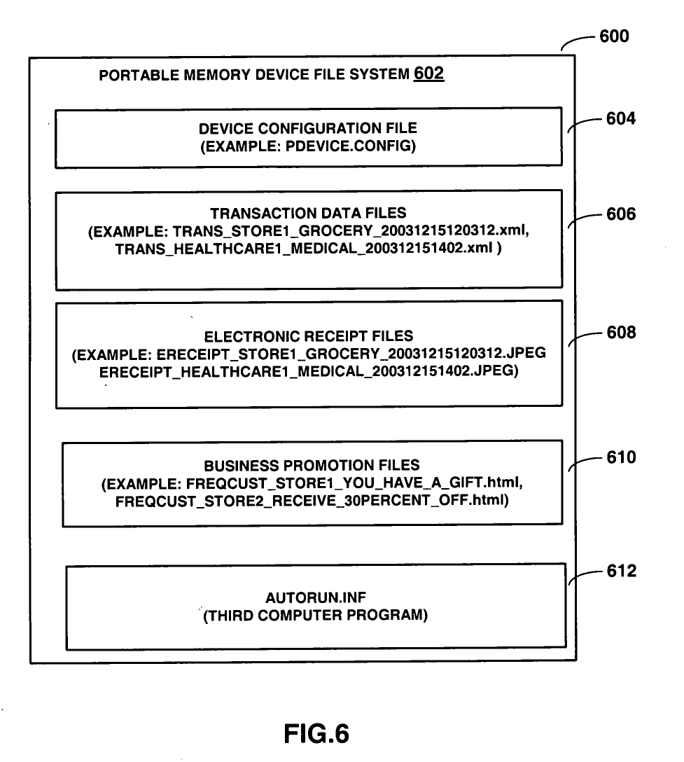

FIG. 6 depicts the block diagram representing an exemplary file system contents 602 of a portable memory device 600, after a customer goes through few iterations of steps 304 to 318 of the data gathering method as illustrated in previous section with reference to FIG. 3. The customer may create a device configuration file 604 in the portable memory device using the second computer program. In one embodiment, the portable memory device consists of only one device configuration file with a fixed name, for example, “PDEVICE.CONFIG”. The device configuration file may comprise a unique customer identification number and other customer preference data parameters that may be used by both of the customer and a vendor during data gathering process. More details on the device configuration file are available in next sections. One or more transaction data files 606 contain the data corresponding to business transactions conducted at a point of sale with one or more vendors and is written by a computer system used by the vendor. Block 608 represents electronic receipt files written by the vendor's computer system, equivalent of paper receipts issued for a business transaction conducted at a point of sale. Block 610 represents other business promotion related files written by the vendor's computer system as a part of the vendor's frequent customer reward program. For example, after buying 10 times from a particular vendor, the vendor may inform the customer about some promotions, either verbally at a point of sale or alternatively, by writing a promotion data file, describing the details of the promotion, which, the customer may browse during leisure. In one embodiment, customer may chose not to receive these types of files from vendors by setting a data parameter in the device configuration file. Block 612 represents the third computer program, that when attached to a computer system, causes the computer to execute the program, which, in turn instructs the second computer program to automatically identify and extract/consolidate the transaction data files 606 and the electronic receipt files 608 from the portable memory 600, into the second database.

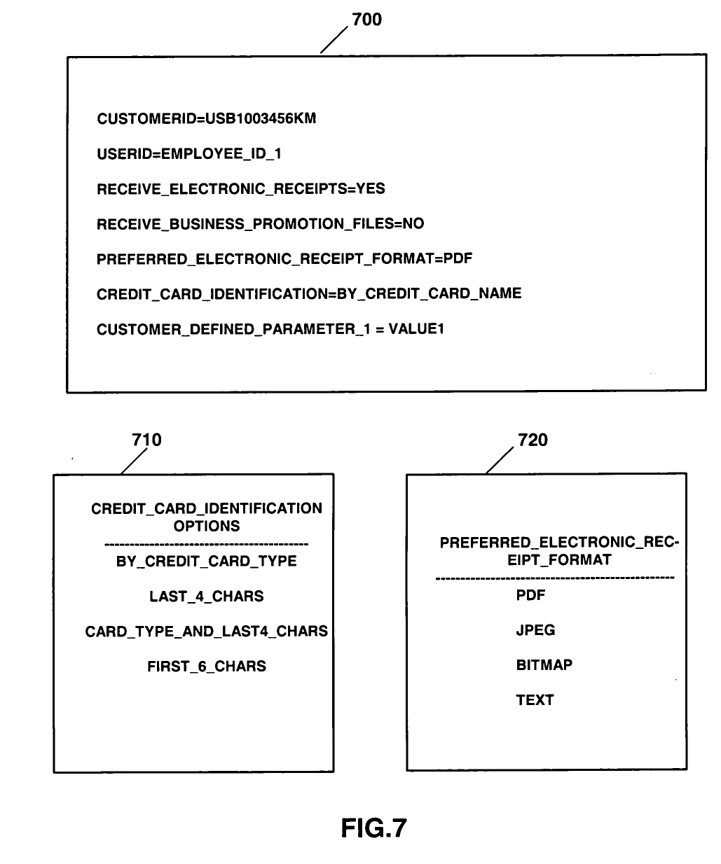

FIG. 7 shows one embodiment of the device configuration file format and it's contents 700, in which a first data parameter “CUSTOMERID” uniquely identifies a customer by the data value “USB1003456KM” and may be created by the second computer program during the portable memory initialization process. A second data parameter “USERID” may be used when there is more than one user per customer, to uniquely identify a household member or an employee of a business customer, using the portable memory. A third data parameter “RECEIVE_ELECTRONIC_RECEIPTS” indicates to the vendor whether the customer is interested in receiving electronic receipts in the portable memory device. It can have values of either “YES” or “NO”. A fourth data parameter “ELECTRONIC_RECEIPT_FORMAT” indicates the preferred format of electronic receipts by the customer. Some of the selection values for this data element is shown in 720, where the format can be well-known PDF format, JPEG, bitmap image or can be in plain text format. A fifth data parameter “CREDIT_CARD_IDENTIFICATION” instructs the vendor, how to identify a credit card in the transaction data files and electronic receipts written to the portable memory device. Typically, customer may not prefer full credit card number appearing in the contents of the data files for security reasons. Using this data parameter in the configuration file, customer may instruct the vendor, the different options of identifying the credit card used for the business transaction. Some of these options are shown in 710, where “BY_CREDIT_CARD_TYPE” may indicate, customer wants to identify the credit card by the credit or debit card types, for example, “visa card”, “master card” etc, or by “LAST_{—}4_DIGITS”, indicating only last 4 characters need to be transferred or “CARD_TYPE_AND_LAST4CHARS”, indicating values like, “visa_{—}3045”, “mastercard_{—}6789” need to be included in the data files. The second computer program may guide the customer in choosing these options by providing a user interface menu and context sensitive help. “CUSTOMER_DEFINED_PARAMETER_{—}1” may contain any data value that is configured by the customer for use by either of customer or vendor. It should be noted that these are only examples and one skilled in the art can appreciate that many variations to the device configuration file are possible, without departing from the scope of the invention. For example, the device configuration file may be in XML format, may contain additional data elements that may be shared between the vendor and the customer. During a point of sale business transaction, the first computer program executing in the vendor's computer system reads these data parameters and tries to adhere to the customer's preferences as indicated in the device configuration file, wherever possible.

In one embodiment, the device configuration file has a fixed file name, like, “DATAGATHER.CONFIG” or “\CONFIG\DATAGATHER.CONFIG” in the portable memory device and there may be only one device configuration file per device. In another embodiment, the device configuration file is identified by the file name extension, like “*.CONFIG” and may contain more than one device configuration file per device. For example, there may be one device configuration file for customer identification, other for electronic receipts preferences etc.

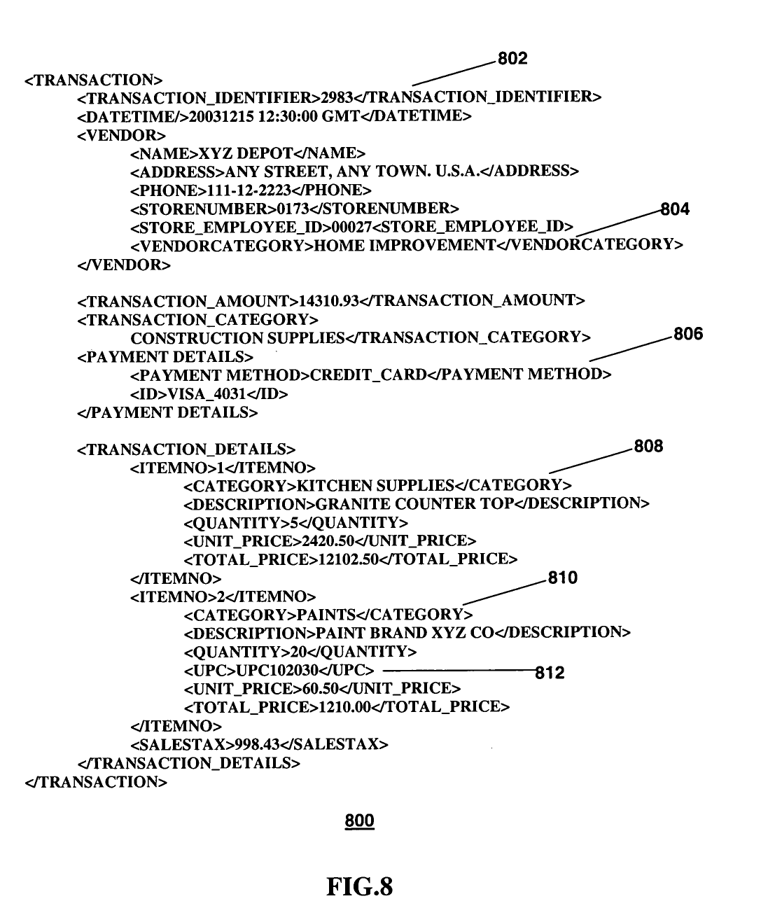

Now referring to FIG. 8, illustrative of the contents 800 of an exemplary transaction data file in XML format, corresponding to a business transaction conducted by a small construction business with a home improvement supplies store, and the transaction data file is received in a portable memory by connecting the portable memory to a computer system used by the home improvement store at a point of sale. Most of the contents of the file are self-explanatory, so only important sections are detailed. Transaction identifier 802 is a transaction identification number provided by the home improvement store. Vendor category 804 provides the main category of the vendor, which, in this example is home improvement. In this example, transaction is paid using a credit card is represented by a XML tag 806. Line item category tags 808 and 810 categorize each transaction item. XML tag 812 is a purchased item identifier, for example, combination of universal product code and serial number.

Some of the steps described in the methods of present invention are implemented using computer programs. In short, a computer program referred in this invention comprised of a multitude of instructions executable by a computer. The computer program may be developed in a computer language with a multitude of instructions that will be translated by the native computer into a machine-readable format and hence executable instructions that can reside in a memory or computer readable mediums and executed by the computer processor or CPU to generate results as described in the teachings of the present invention. Also, computer programs are composed of variables and data structures that either reside locally to a program or are found in memory or storage devices. In general, a computer program may consist of components, modules, objects, routines or sequence of instructions, blocks of code sections, each performing a specific unit of work at different time intervals during the execution of the computer program. Also, computer program may be written in various languages to produce more or less similar results. Furthermore, computer program may be part of an operating system, or other application programs. Any specific nomenclature used in this description is for illustrative purposes only and not to be construed as a limitation.

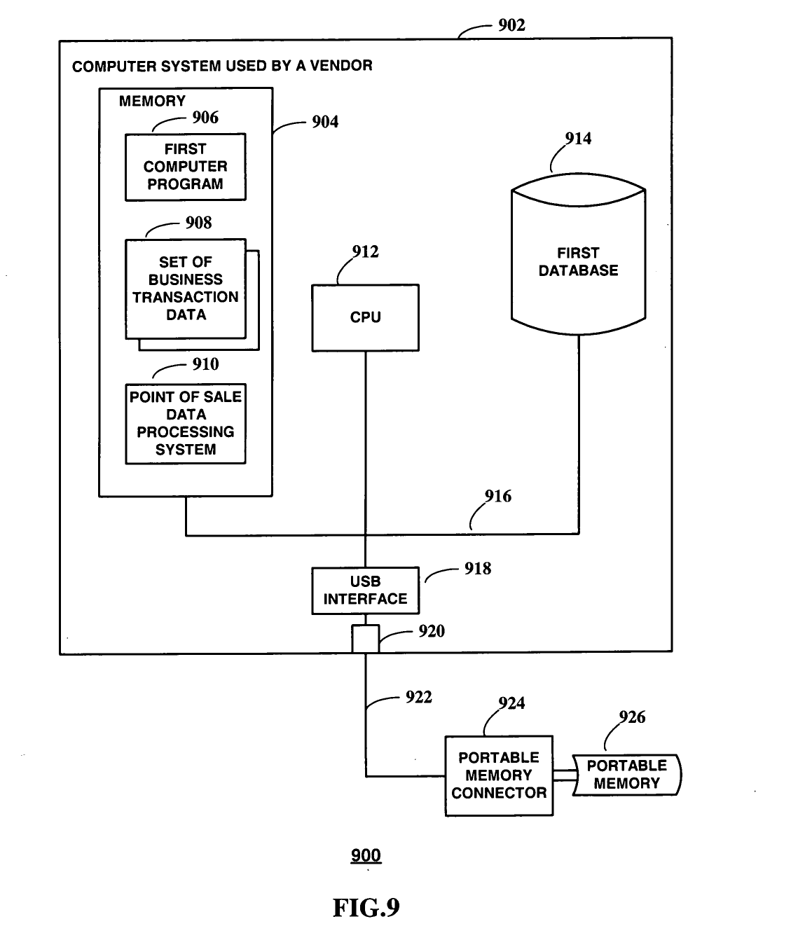

A computer program referred by this invention as the first computer program is provided to a vendor to implement vendor specific portion of the method as described in the methods of the present invention. One exemplary system used by the vendor is illustrated in FIG. 9. Referring now to FIG. 9, an exemplary system 900 comprises a computer system 902 or first computer system 902 used by the vendor to practice the teachings of the present invention, a portable memory connector 924, which is used by a customer to attach and detach a portable memory 926 to and from the computer 902. A connecting means 922 is a data cable that connects the portable memory connector 924 to the computer 902. In general, the routines executed to implement the embodiments of the invention, whether implemented as a stand-alone computer application or as part of an operating system or a specific application or as part of a software product are in the first computer program 906, or the computer program 906. The first computer program 906 resides in a computer readable medium, which is a random access memory 904 of a computer 902 used by the vendor to process point of sale business transactions. The instructions of the computer program 906 can be resident at various times in various memory and storage devices in the computer system 902. When read and executed by one or more processors 912 in the computer 902, the program 906 causes the computer system 902 to perform the steps necessary to execute steps or elements embodying the various aspects of the invention. For example, the computer program 906 receives a set of data 908 from a point of sale data processing program 910, related to a business transaction conducted at a point of sale. The first computer program 906 prepares and creates transaction data and electronic receipt files in the attached portable memory device 926.

Various components of the computer 902 are interconnected to the CPU 912 by the system bus 916. A customer connects the portable memory device 926 by using a portable memory connector 924, which may be placed in convenient location in the point of sale. The portable memory connector 924 is connected to a USB socket 920 of the computer 900 by means of a connecting data cable 922. A USB interface 918 connects the socket 920 to the system bus 916. The first computer program 906 may also read a device configuration file from the portable memory device 926 and associates with one or more data elements from the set of business transaction data 908 and stores in a database 914 or first database 914. The computer program 906 will also display various messages related to the processing of the steps of the methods of the present invention and reads customer and vendor inputs as required. In one embodiment, the database 914 is a relational database.

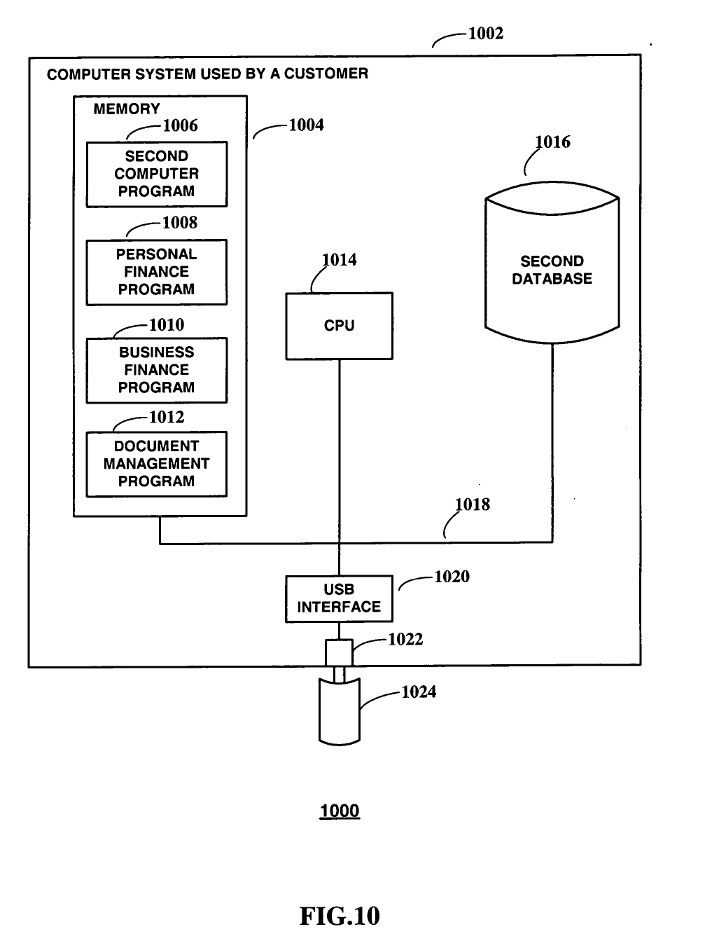

A computer program referred by this invention as the second computer program is provided to a customer to implement customer specific portion of the method as described in the methods of the present invention. One exemplary system used by the customer is illustrated in FIG. 10. Referring now to FIG. 10, an exemplary system 1000 comprising a computer system 1002 or a second computer system 1002 used by the customer to practice the teachings of the present invention and a portable memory device 1024. The conventional computer system 1002 comprises one or more processor or CPU 1014, Random access memory 1004, system bus 1018, USB interface 1020, USB data socket 1022 and a database 1016 or a second database 1016 residing on a non-volatile storage media of the computer 1002. The customer can attach and detach one or more portable memory device 1024 to and from the computer 1002.

In general, the routines executed to implement the customer-specific embodiments of the invention, whether implemented as a stand-alone computer application or as part of an operating system or a specific application, or as part of a software product are in the second computer program 1006, or the computer program 1006. The first computer program 1006 resides in a computer readable medium, which is a random access memory 1004 of a computer 1002 used by the customer. Various other computer programs or computer applications, for example, a personal finance program 1008, a business finance program 1010 and a document management program 1012 are also resident and executed by the CPU 1014. The instructions of the computer program 1006 can be resident at various times in various memory and storage devices in the computer system 1002. When read and executed by one or more processors 1014 in the computer 1002, the program 1006 causes the computer system 1002 to perform the steps necessary to execute steps or elements embodying the various aspects of the invention, that are specific to data gathering by the customer. For example, the computer program 1006 may assist the customer to create a device configuration file in the portable memory device 1024; identifies, extracts and consolidates the files in the portable memory 1024 into second database 1016.

In one embodiment, each installation of the second computer program 1006 comes with a set of customer identification numbers, that are unique across all installations of the second computer program 1006. The customer selects one of the customer identification numbers from the set and creates a customer identification in the device configuration file. In another embodiment, during the device configuration file creation process, the second computer program 1006 connects to a remote web site on the internet and receives unique customer identification number, for example, the remote website may be hosted by the provider of the second computer program 1006.

This invention also discloses an apparatus, using which, a customer can conveniently attach and detach a portable memory device, at a point of sale, to a computer system used by a vendor. This apparatus is necessary to practice the method disclosed in aforementioned sections at a point of sale, where, human assistance from the vendor may not be available. For example, the customer may be conducting business transactions at self-service terminals, for example, fully automated checkout counters, vending machines and automated teller machines. The only way the customer can attach and detach the portable memory device in such self-service terminals is by means of providing the apparatus, which is described in more detail in following sections. In order to get a quick understanding of this apparatus, combination of portable memory connector 924 and connecting data cable 922 of FIG. 9, wherein, the portable memory connector is placed in a point of sale, for the purpose of practicing the methods of this invention, is one embodiment of this apparatus.

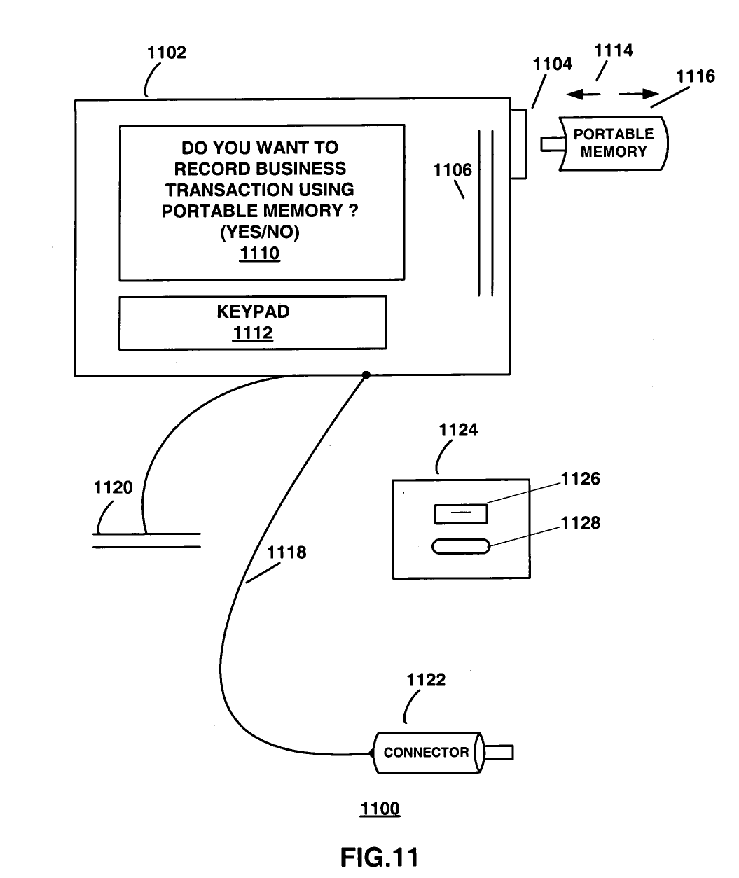

FIG. 11 depicts the apparatus 1100, in accordance with one embodiment of the present invention. A point of sale self-service terminal 1102 is commonly found near the checkout counters in retail and grocery stores. In this illustration, the self-service terminal 1102 comprises a display unit 1110, a keypad 1112 and a magnetic strip reader 1106. An exemplary portable memory connector 1104 is firmly attached to a location in the point of sale, which is easily accessible and visible by the customer. In this illustration, the location is an outer body of the self-service terminal 1102. The customer can attach and detach the portable memory 1116 to and from the portable memory connector as represented by arrows 1114. The self-service terminal 1102 is firmly attached to the point of sale counter surface 1120.

The portable memory connector 1104 contains at least one socket for accepting a portable memory device from the customer. Various sockets of the portable memory connector 1104 are depicted in 1124. The portable memory connector 1124 comprises a USB socket 1126 capable of accepting a unitary portable memory device with a universal serial bus connector and a memory card reader 1128 capable of accepting various types of flash memory cards. It may also contain other data sockets, for example a IEEE 3995 or “firewire” socket capable of accepting unitary portable memory device with IEEE 3995 connector.

The portable memory connector 1104 is connected to a computer system used by the vendor by a first connecting means, which is a combination of data cable 1118 and a data port connector 1122, for example, a USB connector 1122, capable of connecting to a USB data port socket of the computer. In another embodiment, the first connecting means may be a combination of a data cable and second USB socket of the self-service terminal. Normally such second USB socket is used to connect the self-service terminal itself to the computer system of the vendor. In yet another embodiment, the second connecting means may be an infrared beaming device connected to the portable memory connector 1104.

In one example, the customer enters into a point of sale business transaction with a vendor, wherein the point of sale is an automated checkout counter without human assistance. During the business transaction, the vendor's computer system may display a message on display unit 1110, for example, “Do you want to record the business transaction using portable memory?” and waits for the customer response. If the customer response is in the affirmative, the next message instructs the customer to attach the portable memory to the portable memory connector 1104. After the completion of the processing, another message displayed on the display unit 1110 may instruct the customer to detach the portable memory.

It should be noted that the apparatus provides novel and useful results by combining portable memory connector and first connecting means, wherein the portable memory connector is in a position easily accessible by the customer at the point of sale. The prior-art self-service terminals didn't provide such combination to allow the customer to attach a portable memory device like a USB portable memory to receive the business transaction files or to read the portable memory from the customer at a point of sale.

In another embodiment, the portable memory connector 1104 may be part of a self-service terminal, which may be a vending machine, an automated kiosk, an automated checkout counter and an automated teller machine, wherein the portable memory connector is easily accessible and visible by the customer conducting business transaction using such self-service terminals.

The method and apparatus described in present invention may also be practiced in another type of point of sale, wherein the point of sale comprises a hand-held device. For example, an employee of a car rental company may carry the hand-held device to assist in return of rental vehicles in an airport and completes a sale with a rental customer by noting down the gas level, mileage etc. The hand-held device may print a paper receipt corresponding to the rental transaction by using a computer printer of the hand-held device. The car rental company may practice the teachings of present invention by receiving a portable memory device from the rental customer and attaching the portable memory to the hand-held device.

The invention is described using various examples and preferred embodiments herein. However, it should be noted that examples are provided only for illustration and one skilled in the art can readily devise many other varied embodiments that still incorporate these teachings without departing from the scope of the invention. The invention is therefore claimed in any of its forms or modifications within the proper scope of the appended claims.

1. A method of data gathering using a portable memory device, the method comprising:
a customer conducting at least one business transaction with at least one vendor at a point of sale;
connecting said portable memory device to a first computer system used by said vendor, during said business transaction, wherein said portable memory device is received from said customer at said point of sale;
receiving a set of data from a data processing system used by said vendor, wherein said set of data is generated as the result of said customer conducting said business transaction;
preparing data contents of at least one of following data file: a transaction data file and an electronic receipt file, using said set of data and creating at least one of said transaction data file and said electronic receipt file in said portable memory device; and
detaching said portable memory device from said first computer system and said customer receiving back said portable memory device.

2. The method of claim 1, wherein said detaching step further comprising:
disconnecting said portable memory device from an operating system executing in said first computer system; and
notifying at least one of said customer and said vendor to detach said portable memory device from said first computer system.

3. The method of claim 1 further comprising:
connecting said portable memory device to a second computer system; and
identifying at least one of said transaction data file and said electronic receipt file in said portable memory device and extracting each of the identified file into a second database.

4. The method of claim 3 performed by said customer over a period of time, after collecting a plurality of the data files in said portable memory device, corresponding to a plurality of said business transaction from a plurality of said vendor.

5. The method of claim 3, wherein said identifying step is by means of a computer-implemented search of the file system of said portable memory device by using at least one of a pre-determined file name pattern and pre-determined file data content pattern.

6. The method of claim 1 further comprising:
said customer creating a device configuration file in said portable memory device, wherein said device configuration file comprising at least one of a:
unique customer identification data;
unique user identification data;
an indication of whether said customer would like to receive said electronic receipt file into said portable memory device;
an indication of how to represent payment card identification in said transaction data file and said electronic receipt file; and
one or more user defined data.

7. The method of claim 1, wherein said preparing step further comprising:
checking for existence of the device configuration file in said portable memory device;
if the device configuration file exists, extracting the unique customer identification data from the device configuration file; and
associating the unique customer identification data with one or more data elements of said set of data and storing in a first database.

8. The method of claim 7, wherein said vendor using said first database to identify frequent customers.

9. The method of claim 7, wherein said vendor checking for whether said customer qualifies for any business promotion, using the data from said first database and if qualifies, providing the business promotion to said customer.

10. The method of claim 9, wherein said providing the business promotion step is by means of creating a business promotion file in said portable memory device, wherein said business promotion file comprising at least one of:
a textual description of the business promotion provided by said vendor; and
a uniform resource locator hyperlink, when clicked by said customer, directs said customer to a website in the Internet to participate in said business promotion.

11. The method of claim 3, wherein said identifying and extracting step further comprising:
providing a third computer program in said portable memory device, wherein said third computer program automatically starts executing during the said connecting to the second computer system step and when executing, instructs a second computer program executing in said second computer system to automatically identify and extract one or more of the data files into said second database; and
disconnecting said portable memory device and instructing said customer to to detach said portable memory device from said second computer system.

12. The method of claim 1, wherein said customer is represented by a plurality of users, wherein, some or all of the users are provided with said portable memory device and each of said portable memory device is identified by creating unique user identification in the device configuration file in said portable memory device, whereby said customer can gather data from a plurality of said business transaction in a multi-user environment.

13. The method of claim 12 used by said customer for processing employee travel expenses, wherein said user is an employee of said customer.

14. The method of claim 12 used by said customer for consolidating household expenses, wherein said user represent a household member.

15. The method of claim 3, wherein said identifying and extracting step is used in a personal finance management software product.

16. The method of claim 3, wherein said identifying and extracting step is used in a document management software product.

17. The method of claim 3, wherein said identifying and extracting step is used in a business finance management software product.

18. The method of claim 3, wherein said identifying and extracting step is used in an enterprise content management software product.

19. The method of claim 1, wherein said customer is one of an individual, a business entity, a household entity and a government entity.

20. The method of claim 1, wherein said vendor is one of a business entity and a government entity.

21. The method of claim 1, wherein said vendor is one of a seller of products and a seller of services.

22. The method of claim 1, wherein said electronic receipt file is a computer image representation of corresponding paper receipt of said business transaction.

23. The method of claim 1, wherein said transaction data file comprising all of the information that can be found in a corresponding paper receipt of said business transaction.

24. The method of claim 23, wherein said transaction data file further comprising at least one of:
a category of said vendor;
a category of said business transaction; and
a subcategory for each individual line items of said business transaction.

25. The method of claim 1, wherein said transaction data file is in an extensible manipulation language format.

26. The method of claim 1, wherein said data processing system is a data processing system that processes said business transaction at said point of sale.

27. The method of claim 1, wherein said preparing and creating step is used in a software product used for processing said business transaction.

28. The method of claim 1 further comprising:
checking for acceptance criteria of said portable memory device before performing said preparing step, and, if the result from said acceptance criteria is in the negative, disconnecting said portable memory device and notifying at least one of said customer and said vendor to detach said portable memory device from said first computer system, wherein said acceptance criteria comprising at least one of:
checking for whether harmful files exist in said portable memory device; and
checking for existence of identification data of said customer in the device configuration file.

29. The method of claim 1, wherein said portable memory device is a compact flash memory product.

30. The method of claim 29, wherein said portable memory device is a compact memory card.

31. The method of claim 1, wherein said portable memory device is a unitary portable memory device having a universal serial bus connector adapted to the storage device, the device capable of being directly connected to a computer via the connector.

32. The method of claim 1, wherein said portable memory device is a unitary portable memory device having a firewire data port connector adapted to the storage device, the device capable of being directly connected to a computer via the connector.

33. The method of claim 1, wherein said connecting and detaching of said portable memory further comprising:
said customer providing said portable memory device to an individual representing said vendor at said point of sale;
said individual attaching said portable memory device to said first computer system; and
after the completion of processing, said individual detaching said portable memory device and returning back to said customer.

34. The method of claim 1, wherein said connecting and detaching of said portable memory further comprising:
providing an apparatus for attaching and detaching said portable memory device to said first computer system, during said business transaction at said point of sale, by said customer, without human assistance from said vendor, the apparatus comprising:
a portable memory connector for attaching and detaching said portable memory device by said customer, wherein said portable memory connector is attached to a location easily accessible and visible by said customer at said point of sale; and
a first connecting means for connecting said portable memory connector to said first computer system.

35. The apparatus of claim 34, wherein said portable memory connector comprising a universal serial bus socket, placed within a socket case, wherein said universal bus socket is capable of accepting a unitary portable memory device with a universal serial bus connector.

36. The apparatus of claim 34, wherein said first connecting means is combination of a data cable and a data port connector, capable of connecting said portable memory connector to a universal serial bus port of said first computer system.

37. The apparatus of claim 34, wherein said portable memory connector comprising a memory card reader.

38. The apparatus of claim 34, wherein said location is a self-service terminal.

39. The apparatus of claim 38, wherein said self-service terminal is an automatic checkout counter.

40. The apparatus of claim 38, wherein said self-service terminal is an automatic teller machine.

41. The apparatus of claim 38, wherein said self-service terminal is a vending machine.

42. A data gathering method comprising:
a customer creating a identification data in a device configuration file in a portable memory device, wherein said identification data uniquely identifies said customer to a vendor;
said customer entering into a business transaction with said vendor at a point of sale;
connecting said portable memory device to a computer system used by said vendor at said point of sale;
reading said identification data of said customer from said device configuration file;
receiving a set of data from a data processing system, wherein said set of data is generated as the result of said customer conducting said business transaction with said vendor; and
associating one or more of a data element from said set of data with said identification data and storing in a database.

43. The method of claim 42, wherein said creating the identification data is by providing a computer program to said customer, wherein each installation of said computer program has a plurality of customer identification data values that are unique to each of the installation of said computer program, and said customer choosing one customer identification data value from said plurality of customer identification data values and creating said identification data by using the chosen customer identification data value.

44. The apparatus of claim 42, wherein said creating the identification data is by means of said customer connecting to a remote website on the Internet and requesting and receiving said identification data.

45. A method of returning at least one purchased item to a vendor, by a customer, using a portable memory device, the method comprising:
said customer returning the purchased item to said vendor and providing said portable memory device;
receiving the purchased item identification;
performing computer-implemented search for identifying at least one of following data file: a transaction data file and electronic receipt file, in said portable memory device, wherein the data contents of the data file, comprising said purchased item identification; and
visually outputting the data contents of identified data file to said vendor to complete the return transaction.

46. The method of claim 45, further comprising, modifying the identified data file to reflect the return transaction.

47. The method of claim 45, wherein said purchased item is a purchased product.

48. The method of claim 45, wherein said purchased item is a purchased service.

49. The method of claim 45, wherein said purchase item identification is a universal product code.

50. A computer readable medium storing a computer program with a plurality of code sections, when executed by a computer, causes the computer to perform the steps of:
receiving a set of data from a data processing system, wherein said set of data is generated as the result of a customer conducting a business transaction with a vendor at a point of sale;
preparing data contents of at least one of a transaction data file and electronic receipt file using said set of data; and
creating at least one of said transaction data file and said electronic receipt file in a portable memory device, wherein said portable memory device is provided by said customer during said business transaction at said point of sale.

51. The computer readable medium of claim 50, wherein the steps further comprising:
checking for a device configuration file in said portable memory device, and if found, extracting a customer identification data from said device configuration file; and
associating one or more of a data element from said set of data with said customer identification data and storing in a database.

52. The computer readable medium of claim 50, wherein said transaction data file is in a XML format.

53. The computer readable medium of claim 50, wherein said electronic receipt file is in a computer image format.

54. The computer readable medium of claim 50, wherein said transaction data file is in a personal finance management software program readable format.

55. The computer readable medium of claim 50, wherein said transaction data file is in a business finance management software program readable format.

56. The computer readable medium of claim 50, wherein the steps further comprising:
creating multiple user interaction sessions at different time intervals during various stages of execution of said computer program for presenting a plurality of messages to at least one of said customer and said vendor and receiving a plurality of inputs from at least one of said customer and said vendor.

57. The computer readable medium of claim 50, wherein said computer program is part of a software product handling business transactions at said point of sale.

58. A computer readable medium storing a computer program with a set of instructions that, when executed by a computer, causes the computer to perform the steps of:
receiving at least one purchased item identifier corresponding to a purchased item by a customer;
identifying at least one of following data file: a transaction data file and an electronic receipt file in a portable memory device connected to the computer, wherein the data file contents comprising a data value matching with said purchased item identifier and portable memory device is provided by said customer; and
displaying the data file contents to a vendor using a display unit of the computer to assist said vendor to complete a return transaction.

59. The computer readable medium of claim 58, wherein the steps further comprising:
modifying the data file in said portable memory device to reflect the return transaction.

60. The computer readable medium of claim 58, wherein said computer program is part of a point of sale software product.

61. A computer readable medium storing a computer program with a plurality of code sections, when executed by a computer, causes the computer to perform the steps of:
identifying at least one of the following data file: a transaction data file and an electronic receipt file, in a portable memory device attached to said computer, wherein the data files are received by a customer from one or more vendors at a point of sale; and
extracting each of the data file into a database.

62. The computer readable medium of claim 61, wherein said identifying step is by means of searching for the data files by using at least one of a file name pattern and data content pattern and receiving a list of matching files.

63. The computer readable medium of claim 61, wherein said steps further comprising:
creating a device configuration file in said portable memory device with at least one of:
first data parameter assigned with unique customer identification data value;
second data parameter assigned with unique user identification data value;
third parameter assigned with the customer choice indicating whether the customer would like to receive the electronic receipt file in said portable memory device;
fourth parameter assigned with the customer choice indicating whether the customer would like to receive a business promotion file in said portable memory device; and
fifth data parameter assigned with a data value selected from a plurality of values, indicating how the vendor should identify a payment card used for the business transaction in the transaction and electronic receipt files.

64. The computer readable medium of claim 61, wherein said identifying and extracting step is used in a personal finance management software product to automatically extract the data files into said database, wherein said database is a database used by said personal finance management software product.

65. The computer readable medium of claim 61, wherein said identifying and extracting step is used in a business finance management software product to automatically extract the data files into said database, wherein said database is a database used by said business finance management software product.

66. The computer readable medium of claim 61, wherein said identifying and extracting step is used in a document management software product to automatically extract the data files into said database, wherein said database is a database used by said document management software product.

67. The computer readable medium of claim 61, wherein said identifying and extracting step is used in an enterprise content management software product to automatically extract the data files into said database, wherein said database is a database used by said enterprise content management software product.

68. The computer readable medium of claim 61 further comprising:
a set of customer identification data values, wherein said set of customer identification data values are unique and distributed with each installation of said customer program and said customer selecting one data value from said set of customer identification data values and using the data value as the unique customer identification data in the device configuration file.

69. The computer readable medium of claim 61, wherein the steps further comprising:
creating multiple user interaction sessions at different time intervals during various stages of execution of said computer program for presenting a plurality of messages to said customer and receiving a plurality of inputs from said customer.

70. An apparatus for attaching and detaching a portable memory device to a computer system used by a vendor, during a business transaction at a point of sale, by a customer, without human assistance from a vendor, the apparatus comprising:
a portable memory connector for attaching and detaching said portable memory device by said customer, wherein said portable memory connector is attached to a location easily accessible and visible by said customer at said point of sale; and
a first connecting means for connecting said portable memory connector to said computer system.

71. The apparatus of claim 70, wherein said portable memory connector comprising a universal serial bus socket, placed within a socket case, wherein said universal bus socket is capable of accepting a unitary portable memory device with a universal serial bus connector.

72. The apparatus of claim 70, wherein said first connecting means is combination of a data cable and a data port connector, capable of connecting said portable memory connector to a universal serial bus port of said computer system.

73. The apparatus of claim 70, wherein said portable memory connector comprising a memory card reader.

74. The apparatus of claim 70, wherein said location is a self-service terminal.

75. The apparatus of claim 74, wherein said self-service terminal is an automatic checkout counter.

76. The apparatus of claim 74, wherein said self-service terminal is an automatic teller machine.

77. The apparatus of claim 74, wherein said self-service terminal is a vending machine.
